(19) United States
(12) Patent Application Publication
(10) Pub. No.: US 2005/0140157 A1
(43) Pub. Date: Jun. 30, 2005

(54) Center console assembly having integrated soft-touch aesthetic feature and method of manufacturing same

(76) Inventor: David M. Emerling, West Bloomfield, MI (US)

Correspondence Address: LEAR CORPORATION, BLISS MCGLYNN, P.C., 2075 WEST BIG BEAVER ROAD, SUITE 600, TROY, MI, 48084, US

(21) Appl. No.: 10/748,356

(22) Filed: Dec. 30, 2003

(51) Int. Cl. B60R 7/04

(52) U.S. Cl. 296/24.34

(57) ABSTRACT

The present invention relates to a method of manufacturing a center console assembly having an integrated soft-touch area including actuating a core within a mold cavity so as to partition at least one area of the mold cavity, to prevent a first molten thermoplastic material from completely filling the mold cavity. A first molten thermoplastic material having a predetermined density is then injected into a mold cavity so as to fill the mold cavity thereby forming a structural element. The core is then retracted within the mold cavity to provide at least one secondary void within the mold cavity. A second molten thermoplastic material having a density less than the predetermined density of the first molten thermoplastic material is then injected into said secondary void of the mold cavity to form at least one soft-touch area bonded to and adjacent at least a portion of the structural element.

### BACKGROUND OF THE INVENTION

1. Field of the Invention

The present invention relates, generally, to a center console assembly for automotive vehicle interiors. More specifically, the present invention relates to a center console assembly having an integrated soft-touch feature and method of manufacturing same.

2. Description of the Related Art

Interior trim components for automobiles commonly include a center console assembly disposed between the seats. Typically, a center console assembly includes a cover or lid that provide access to an internal compartment within the center console assembly where passengers may stow objects such as coins, maps, sunglasses, compact discs, etc. The cover or lid is most often a padded or “soft-touch” component of the center console. The soft-touch areas of the center console assembly often serve as an armrest for seat occupants.

The soft-touch area of a center console assembly includes components manufactured independent from the center console per se and subsequently assembled thereto. Traditionally, these components include a plurality of pre-formed components such as a rigid substrate, foam intermediate layer and coverstock among others. The rigid substrate is often constructed from a polymer and manufactured via an injection molding process. In this case, a mold cavity must be tooled to conform to the predetermined dimensions of the soft-touch area. The intermediate layer is typically a pre-formed flexible-foam or elastomeric pad of varying thickness. The intermediate layer may be purchased in sheet form and subsequently trimmed to correspond to the shape of the rigid substrate. While neither of these pre-formed components is visible from the vehicle interior, they still require assembly, manufacture, and handling separate from actually assembling the soft-touch area, resulting in a significant cost factor associated with this effort.

The top surface of the soft-touch area is commonly referred to as, “coverstock” which includes a “class-A” surface that is visible from the vehicle interior when installed and a “class-B” surface that contacts the foam intermediate layer. The coverstock may be constructed from any number of materials to provide a durable yet aesthetic surface layer for the soft-touch area. By way of example, coverstock materials such as leather, cloth, or high-grade polymers, which often impart a textured class-A surface simulating the grain of leather, may be employed to cover the soft-touch area. Because the coverstock must be durable and provide an aesthetically pleasing class-A surface, the coverstock is often the most costly component of the center console when compared to the rigid substrate and foam intermediate layer. Further, the coverstock requires secondary handling to trim the material to correspond to the predetermined shape of the soft-touch area.

In addition to the cost associated with manufacturing the pre-formed components of the soft-touch area of a center console, there are additional cost factors associated with assembling these pre-formed components. More specifically, the lid often requires extensive labor to stretch the coverstock, sew and/or glue the components together. The additional handling and assembly efforts required to assemble a center console lid having a soft-touch area may also give rise to defective or substandard assembly, resulting from improper fitting of the three components or misalignment during the sewing and/or gluing process. In any event, the secondary handling and assembly as well as the production of substandard products result in increased costs to produce the a center console assembly with a soft-touch area.

There are several different known processes that may be employed to manufacture a center console assembly having an integrated soft-touch aesthetic feature such as a center console lid and/or armrest. By way of example, processes involving low pressure molding, structural reaction injection molding, and vacuum forming have all been employed to reduces the costs associated with assembling the substrate, intermediate foam layer and coverstock to produce a center console assembly having an integrated soft-touch aesthetic feature. These processes involve securing the coverstock to the substrate and subsequently placing a foam intermediate layer therebetween.

However, each of the above-identified processes require assembly of the coverstock, intermediate layer, and substrate which also requires additional, secondary handling. More importantly, each of the above-identified processes employ a coverstock which is associated with the higher part cost, and increased assembly and secondary handling to manufacture a center console having a lid or an armrest with an integrated soft-touch aesthetic feature. Furthermore, each of the above-identified processes may result in the production of a center console having and irregular/misshapen soft-touch area.

While the center consoles having an integrated soft-touch area of the type known in the related art have generally worked for their intended purposes, there remains a need in the related art to reduce the number of steps required to manufacture a vehicle center console assembly incorporating a soft-touch area. Further, there remains a need in the art to reduce the costs associated with manufacturing a vehicle center console assembly incorporating a soft-touch area. In addition, there remains a need for a vehicle center console assembly that includes an integrated soft-touch area having improved quality. Finally, there remains a need in the art for a vehicle center console assembly that provides a consistent, desirable, class-A surface that is aesthetically pleasing.

### SUMMARY OF THE INVENTION

The present invention overcomes the disadvantages in the related art in center consoles for vehicles and generally fulfills a need in the art for a method of manufacturing a component of a center console assembly having an integrated soft-touch area for improved aesthetic and ergonomic center console quality. To this end, the method of the present invention includes actuating a core within a mold cavity so as to partition at least one area of the mold cavity to prevent a first molten thermoplastic material from completely filling the mold cavity. A first molten thermoplastic material having a predetermined density is then injected into a mold cavity so as to fill the mold cavity thereby forming a structural element. The core is then retracted from within the mold cavity to provide at least one secondary void within the mold cavity. A second molten thermoplastic material having a density less than the predetermined density of the first molten thermoplastic material is then injected into the secondary void of the mold cavity to form at least one soft-touch area bonded to and adjacent at least a portion of the structural element.

Accordingly, one advantage of the present invention is that it provides an integrated soft-touch area on a structural component of the center console where the component is formed in a mold to reduce the steps necessary to manufacture the vehicle center console assembly.

Another advantage of the present invention is that it provides an integrated soft-touch area during manufacture of the center console assembly that eliminates quality issues relating to positive alignment during later assembly of a soft-touch area.

Yet another advantage of the present invention is that it provides a monolithic soft-touch area to reduce cushion variation within the soft-touch area for improved aesthetic quality of the vehicle interior.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an environmental view of a partial interior of a vehicle including a center console assembly having an integrated soft-touch aesthetic feature of the present invention;

FIG. 2 is a cross-sectional view of a component of a center console having an integrated soft-touch aesthetic feature of the present invention;

FIG. 3A is a perspective view illustrating the molding process employed to manufacture a center console assembly having an integrated soft-touch feature of the present invention;

FIG. 3B is a perspective view of the mold with the center console assembly receiving an integrated soft-touch feature of the present invention shown in phantom; and

FIG. 3C is a perspective view of the mold and center console assembly having an integrated soft-touch feature of the present invention.

### DETAILED DESCRIPTION OF THE INVENTION

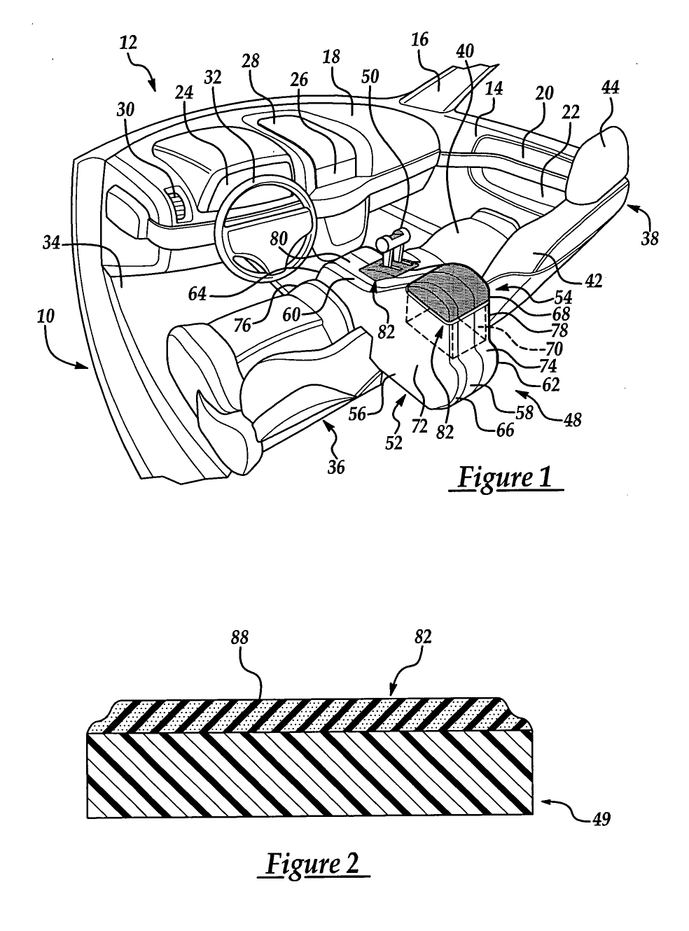

A vehicle interior that employs the center console assembly of the present invention is generally indicated at 10 in FIG. 1, where like numbers are used to designate like structure throughout the figures. As shown in FIG. 1, the interior 10 of a vehicle, generally indicated at 12, is defined by a plurality of trim components, namely a door trim panel 14, door pillar 16, and a dashboard 18 to provide ergonomic and/or aesthetic features to the interior 10 of a vehicle 12. By way of example, the door trim panel 14 includes a bolster 20 and an armrest 22 to provide comfort to a vehicle occupant while the dashboard 18 includes an instrument panel 24 and on-board display 26 to provide vehicle information to the vehicle occupant. The dashboard 18 further includes other features such as a storage deck 28 and a vent 30 for the vehicle's heating ventilation and air conditioning system. The vehicle interior 10 is further defined by a steering wheel 32 adjacent the instrument panel 24, a vehicle floor 34 and plurality of seats, generally indicated at 36 and 38 mounted to the vehicle floor 34. FIG. 1 includes a passenger seat 38 having a seat bottom 40, seat back 42 and headrest 44, while the driver seat 36 is shown in cut-away form to further reveal a center console assembly of the present invention generally indicated at 48. However, those having ordinary skill in the art will appreciate that the driver seat 36 includes features similar to that of the passenger seat 38. Further, those having ordinary skill in the art will appreciate that the interior 10 of a vehicle 12 may be further defined by rear seats, rear doors, etc. as dictated by the style of a vehicle, as is commonly known in the art.

As noted above, the center console assembly 48 is shown for use within the interior 10 of a vehicle 12. Specifically, the center console assembly 48 is mounted to a vehicle floor 34 and disposed between the driver and passenger seats 36, 38. While the center console assembly 48 of the present invention is shown mounted between the seats 36, 38, those having ordinary skill in the art will appreciate that it may be employed anywhere within a vehicle interior 10 where a center console assembly 48 is desired. By way of example, the present invention may be employed in the rearward interior 10 of a vehicle 12 such as a van or employed as a foldable center console in connection with a bench-style seat. Further, the center console assembly 48 is shown in FIG. 1 having an elongated form and including a gearshift handle 50 extending therefrom. Those having ordinary skill in the art will appreciate that the center console assembly 48 of the present invention may include any form that corresponds to the interior styling of a vehicle 12 and may or may not be adapted to accommodate components within the interior 10 of a vehicle 12 such as a gearshift handle 48, cup holder, ashtray, etc. By way of example the center console assembly 48 may be employed in connection with a bench-style seat and includes a more compact and box-like form.

As illustrated in the figures, the center console assembly 48 includes a plurality of structural elements, generally indicated at 49. For example, the center console assembly 48 includes a housing generally indicated at 52, and a lid, generally indicated at 54, that is hingedly supported relative to the housing 52. The housing 52 is defined by a plurality of sidewalls 56, 58, 60, 62, 64 having a predetermined shape that corresponds to the designated style and area of a particular vehicle interior location that is adapted to receive a center console assembly 48. Those having ordinary skill in the art will appreciate that the sidewalls 56, 58, 60, 62, 64 may include any predetermined shape to compliment the aesthetic features within the interior 10 of a vehicle 12. By way of example, the sidewall 58 shown in FIG. 1 includes beveled edges 66, 68 and a predetermined contour that corresponds to the transition between the seat back and seat bottom of the driver and passenger seats 36, 38 for improved aesthetic and ergonomic quality of the interior 10 of a vehicle 12.

The sidewalls 56, 58, 60, 62, 64 also cooperate to define an interior compartment, shown in phantom at 70, within the housing component 52 of the center console assembly 48 as generally known in the related art. The interior compartment 70 provides an area in which various articles such as maps, compact discs, and other articles may be stowed. Further, the interior compartment 70 may include molded areas adapted to retain specific articles such as sunglasses or coins and may also include a removable bin for portable storage of the stowed articles and otherwise improve the aesthetic and ergonomic quality of the interior of a vehicle. The sidewalls 56, 58, 60, 62, 64 further include at least a portion that is visible from the interior 10 of a vehicle 12 and presents a class-A surface 72, 74, 76, 78, 80. The class-A surface 72, 74, 76, 78, 80 may include a texture or grain to further improve the aesthetic quality of the vehicle interior 10.

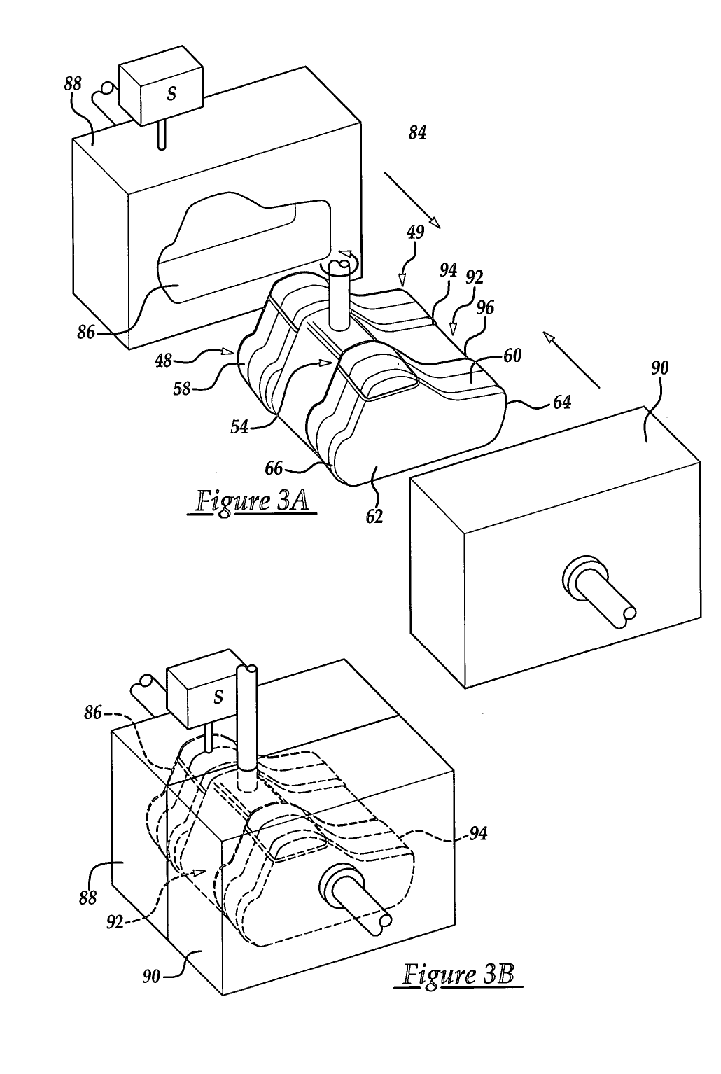

Further, the housing component 52 and the lid 54 may also include a soft-touch area, generally indicated at 82, bonded to and formed adjacent at least a portion of an underlying structural element 49. A generic representation of a soft-touch area 82 bonded to and formed adjacent at least a portion of the structural element 49 is shown in FIG. 2. Specifically, the soft-touch area 82 is bonded to and formed adjacent the structural element 49 of either the sidewall 56, 58, 60, 62, 64 or the lid 54 while the housing component 52 or lid 54 is at least partially formed in a mold, generally indicated at 84 having a mold cavity 86 to reduce the costs associated with manufacturing a component 52, 54 of the center console assembly. The soft-touch area 82 of the center console assembly 48 includes a class-A surface 88 that not only eliminates the need for a coverstock material, but also eliminates the need for an intermediate layer as well, thereby reducing the likelihood of deformation or an otherwise irregular cushion-like feel as a result of a substandard intermediate layer and thereby improve the aesthetic quality of the vehicle interior 10. Referring to FIG. 1, a soft-touch area 82 is bonded to at least one sidewall 60 disposed adjacent the gearshift handle 50 as well as on the lid 54 of the console 48. However, those having ordinary skill in the art will appreciate that the soft-touch area 82 may be employed anywhere along the sidewalls 56, 58, 60, 62, 64 so as to be visible from the interior of a vehicle 12 and may present any color or pattern. Further, those having ordinary skill in the art will appreciate that the soft-touch area 82 of the lid component 54 as shown in FIGS. 1, 2, and 3C may also serve as an armrest to not only improve the aesthetic quality of the vehicle interior 10, but the ergonomic quality as well.

As noted above, housing and lid components 52, 54 of the center console assembly 48 of the present invention are formed via an injection molding process. The components 52, 54 of the center console assembly 48 having the soft-touch area 82 are formed via a two-shot injection mold system. In this way, the structural elements 49 of the components 52, 54 are essentially co-molded with the soft forming elements of the soft-touch area 82. The method of the present invention includes the steps of injecting a first molten thermoplastic material having a predetermined density into a mold cavity having an actuated core. When actuated, the core partitions a portion of the mold cavity so as to prevent the first thermoplastic material from completely filling the mold cavity. The first thermoplastic material may include any rigid forming material suitable for use in an injection mold. By way of example the material employed may include nylon, polypropylene, acrylonitrile butadiene styrene (ABS), polyvinyl chloride (PVC) or thermoplastic olefin (TPO) or other rigid forming material.

The first molten thermoplastic material forms a structural element 49 in the mold cavity, defining a component 52, 54 of the center console assembly 48. This structural element 49 may correspond either to the housing component 52 or the lid component 54. In either event, upon the lapse of a predetermined amount of time that is specific to the material and mold process conditions, the core is retracted to define a secondary void within the mold cavity. A second molten thermoplastic material is then injected into the secondary void of the mold cavity while the structural element remains tacky. The second molten thermoplastic material includes a density less than that of the first molten thermoplastic material and is bonded to the structural element within the mold cavity. Thus, the second molten thermoplastic material has a softer, more tactile and comfortable feel once it has solidified and cooled than that of the first molten thermoplastic material. Those having ordinary skill in the art will appreciate that any material adapted for use in an injection mold that provides the desired soft-touch feel may be employed. Specifically, the second thermoplastic material imparts a soft-touch area 82 that is bonded to and adjacent at least a portion of the structural element 49. Where the structural element 49 is the lid component 54, the soft-touch area 82 may substantially cover one surface as illustrated in FIG. 2. Generally speaking, the manner in which the structural element 49 receives the soft-touch area 82 streamlines the manufacturing of a center console assembly 48 by eliminating the need for a coverstock and intermediate cushion layer, as well as other secondary handling processes.

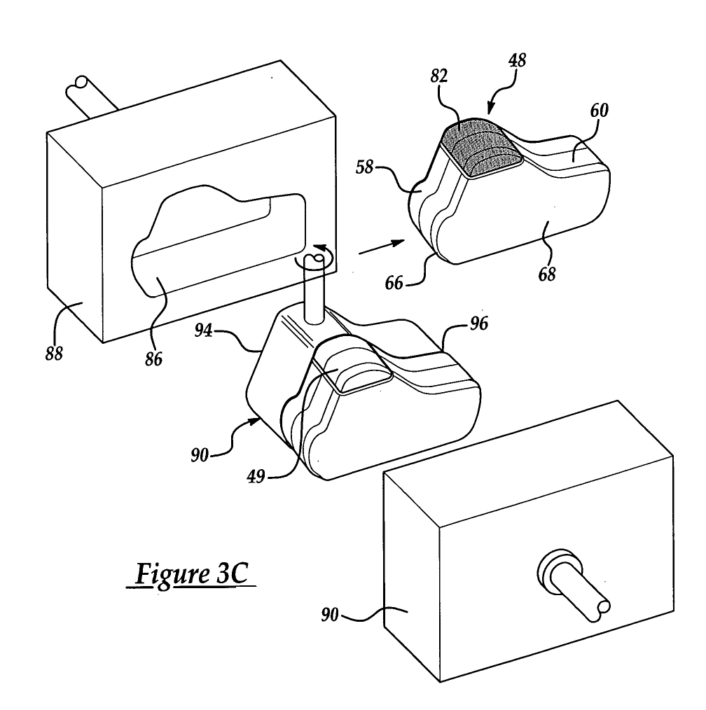

Another method employing the two shot injection mold system to manufacture a component of the center console assembly 48 is illustrated in FIGS. 3A-3C. This method involves providing a mold 84 having a first and second die halves 88, 90 and a core, generally indicated at 92, moveably supported relative to the die halves 88, 90, while maintaining the same co-molded methodology as above-identified. The core 92 is disposed between the first and second die halves 88, 90 to define a first and second mold cavity 86, 94. A first molten thermoplastic material having a predetermined density is injected into the first mold cavity 86, thereby forming a structural element 49. Again, the structural element 49 formed in the first mold cavity 86 may define either the housing component 52 or the lid component 54 and the first molten thermoplastic material includes the same considerations as defined above.

Following a predetermined lapse of time to permit the structural element 49 to partially cure within the first mold cavity 86, the core 92 is moved relative to the first and second die halves 88, 90 to define a second mold cavity 94. In the preferred embodiment illustrated here, the core is moved in a rotating manner to form the second mold cavity 94 and a second molten thermoplastic material, having a density less that the predetermined density of the first thermoplastic material, is injected into the second mold cavity 94 from a source (S). As noted above, the second molten thermoplastic material has a softer, more tactile and comfortable feel once it has solidified and cooled than that of the first molten thermoplastic material. The second injected molten thermoplastic material forms at least one soft-touch area 82 bonded to and adjacent at least a portion of the structural element 49 of the formed component.

As illustrated in FIGS. 3A-3C, the core 92 includes a first surface 94 and a second surface 96 opposite the first surface 94. The first and second surfaces 94, 96 of the core 92 are the virtually identical to provide efficient manufacture of center console components 52, 54. Specifically, while the second molten thermoplastic material is injected into the second mold cavity 94, the opposed core surface receives the injection of a first molten thermoplastic material in the first mold cavity 86. However, those having ordinary skill in the art will appreciate that the core 92 need not include two surfaces to employ the above-described method.

The center console assembly 48 of the present invention reduces the steps necessary to manufacture a vehicle center console assembly 48 having a soft-touch area 82 by eliminating the need for a coverstock. Further, the center console assembly 48 of the present invention bonds the soft-touch area 82 to the center console component while in a mold cavity to eliminate quality issues relating to positive alignment during later assembly of a soft-touch area 82. Still further, the soft-touch area 82 is injected onto the center console component to provide a uniform feel, thereby reducing cushion variation within the soft-touch area 82 and eliminates the need for an intermediate foam layer to impart a soft-touch area 82.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A method of manufacturing a component of a center console assembly for the interior of a vehicle, said method comprising the steps of:
actuating a core within a mold cavity so as to partition at least one area of said mold cavity, to prevent a first molten thermoplastic material from completely filling said mold cavity;
injecting said first molten thermoplastic material having a predetermined density into a mold cavity so as to fill said mold cavity thereby forming a structural element defining a substrate that serves as a lid of a center console;
retracting the core within the mold cavity to provide at least one secondary void within said mold cavity; and
injecting a second molten thermoplastic material having a density less than the predetermined density of said first molten thermoplastic material into said secondary void of said mold cavity to form at least one soft-touch area bonded to and adjacent at least a portion of said structural element to define a soft-touch area on said lid.

2. The method as set forth in claim 1 wherein the step of retracting the core within the mold cavity further includes the step of permitting a predetermined lapse of time prior to retracting said retractable core to permit said structural element to partially cure.

3. (canceled)

4. A method of manufacturing a component of a center console assembly for the interior of a vehicle, said method comprising the steps of:
actuating a core within a mold cavity so as to partition at least one area of said mold cavity, to prevent a first molten thermoplastic material from completely filling said mold cavity;
injecting said first molten thermoplastic material having a predetermined density into a mold cavity so as to fill said mold cavity thereby defining a housing of a center console having a plurality of sidewalls that define an interior compartment;
retracting the core within the mold cavity to provide at least one secondary void within said mold cavity: and
injecting a second molten thermoplastic material having a density less than the predetermined density of said first molten thermoplastic material into said secondary void of said mold cavity to form at least one soft-touch area, said second thermoplastic material bonded to and adjacent at least a portion of at least one sidewall that is visible from the interior of a vehicle.

5. The method as set forth in claim 1 wherein the step of injecting a second molten thermoplastic material further includes injecting a thermoplastic material having different color than the color of said first molten thermoplastic material.

6. A method of manufacturing a component of a center console assembly for the interior of a vehicle, said method comprising the steps of:
providing a mold having first and second die halves and a core moveably supported relative to said die halves and disposed therebetween to define a first and second mold cavity between said moveable core and said first and second die halves;
injecting a first molten thermoplastic material having a predetermined density into said first mold cavity so as to fill said first mold cavity thereby forming a structural element that defines a substrate that serves as a lid for a center console;
moving said core relative to said first and second die halves to define said second mold cavity; and
injecting a second molten thermoplastic material having a density less than the predetermined density of said first molten thermoplastic material into said second mold cavity thereby forming at least one soft-touch area bonded to and adjacent at least a portion of said structural element to define a soft-touch area on said lid.

7. The method as set forth in claim 6 wherein the step of moving said core to define said second mold cavity further includes the step of permitting a predetermined lapse of time prior to injecting a second molten thermoplastic material to permit said structural element to partially cure.

8. (canceled)

9. (canceled)

10. The method as set forth in claim 6 wherein the step of injecting a second molten thermoplastic material further includes injecting a thermoplastic material having different color than the color of said first molten thermoplastic material.

11-16. (canceled)

17. The method as set forth in claim 4 wherein the step of retracting the core within the mold cavity further includes the step of permitting a predetermined lapse of time prior to retracting said retractable core to permit said structural element to partially cure.

18. The method as set forth in claim 1 wherein the step of injecting a second molten thermoplastic material further includes injecting a thermoplastic material having different color than the color of said first molten thermoplastic material.
